(19) United States
(12) Patent Application Publication
(10) Pub. No.: US 2025/0117821 A1
(43) Pub. Date: Apr. 10, 2025

(54) Method, System, and Computer Program Product for Encoding Offers

(71) Applicant: Visa International Service Association, San Francisco, CA (US)

(72) Inventors: Yashaswini Shetty, Bangalore (IN); Tejaswini Katta, Bengaluru (IN); Madhuri Vikram Lengade, Bengaluru (IN)

(21) Appl. No.: 18/376,504

(22) Filed: Oct. 4, 2023

(51) Int. Cl. G06Q 30/0207; G06Q 20/32; G06Q 30/0238

(52) U.S. Cl. CPC G06Q 30/0224; G06Q 20/3274; G06Q 30/0238

(57) ABSTRACT

A method, system, and computer program product are provided for embedding an offer. The method includes receiving transaction data for a transaction between a user and a merchant, determining an offer based on the transaction data, the offer corresponding to offer data, generating machine-readable indicia comprising encoded data, the encoded data comprising at least a portion of the transaction data and the offer data, receiving a payment request from a user device of the user based on the encoded data and account data associated with a user account of the user, and in response to receiving the payment request, automatically applying the offer data to at least one of the transaction and the user account.

### BACKGROUND

### 1. Field

This disclosure relates generally to encoding offers and, in some non-limiting embodiments or aspects, to methods, systems, and computer program products for encoding offers by embedding loyalty data in a machine-readable code.

### 2. Technical Considerations

A customer may initiate a push payment transaction with a merchant by scanning a barcode encoded with data (e.g., merchant data and/or transaction data). After the push payment transaction is processed, the customer may receive a transaction message indicating that the push payment transaction has been successfully completed. In some cases, the customer may be enrolled in a loyalty and/or rewards program with the merchant. For example, a customer may have a customer account with the merchant where loyalty and/or reward information is stored. Typically, if a merchant wants to communicate offer data (e.g., loyalty data, rewards data, etc.) to the customer based on the push payment transaction, the merchant must generate and communicate a separate message to the customer including the offer data.

### SUMMARY

According to non-limiting embodiments or aspects, provided is a computer-implemented method for encoding offers. In some non-limiting embodiments or aspects, the method may include receiving, by at least one processor, transaction data for a transaction between a user and a merchant. In some non-limiting embodiments or aspects, the method may further include determining, by at least one processor, an offer based on the transaction data, the offer corresponding to offer data. In some non-limiting embodiments or aspects, the method may further include generating, by at least one processor, machine-readable indicia including encoded data, the encoded data including at least a portion of the transaction data and the offer data. In some non-limiting embodiments or aspects, the method may further include receiving, by at least one processor, a payment request from a user device of the user based on the encoded data and account data associated with a user account of the user. In some non-limiting embodiments or aspects, the method may further include in response to receiving the payment request, automatically applying, by at least one processor, the offer data to at least one of the transaction and a user account.

In some non-limiting embodiments or aspects, the method may further include receiving the account data associated with the user account of the user before determining the offer; and determining whether the user is eligible for the offer based on the account data associated with the user account of the user.

In some non-limiting embodiments or aspects, when determining whether the user is eligible for the offer, the method may include querying a database in response to receiving the account data associated with the user account of the user; and receiving the offer data from the database.

In some non-limiting embodiments or aspects, generating the machine-readable indicia may include generating the encoded data by encoding the at least a portion of the transaction data and the offer data; and generating the machine-readable indicia including the encoded data in response to determining the user is eligible for an offer.

In some non-limiting embodiments or aspects, the encoded data may include a plurality of fields, and generating the machine-readable indicia including the encoded data may include: receiving the offer data from a merchant server; modifying a data structure for the machine-readable indicia by embedding the offer data into a field of the plurality of fields and embedding the at least a portion of transaction data in at least one other field of the plurality of fields; and generating the machine-readable indicia based on the data structure and at least one indicia generation algorithm.

In some non-limiting embodiments or aspects, the machine-readable indicia may be at least one of the following: a two-dimensional barcode, a quick response (QR) code, a Bharat QR code, and/or any combination thereof.

In some non-limiting embodiments or aspects, the method may further include: generating a push notification including the offer data in response to the transaction being authorized; and communicating the push notification to a user device of the user.

In some non-limiting embodiments or aspects, the transaction may be a push payment transaction initiated by the user.

According to non-limiting embodiments or aspects, provided is a system for encoding offers. In some non-limiting embodiments or aspects, the system may include at least one processor programmed or configured to receive transaction data for a transaction between a user and a merchant. In some non-limiting embodiments or aspects, the at least one processor may be programmed or configured to determine an offer based on the transaction data, the offer corresponding to offer data. In some non-limiting embodiments or aspects, the at least one processor may be programmed or configured to generate machine-readable indicia including encoded data, the encoded data including at least a portion of the transaction data and the offer data. In some non-limiting embodiments or aspects, the at least one processor may be programmed or configured to receive a payment request from a user device of the user based on the encoded data and account data associated with a user account of the user. In some non-limiting embodiments or aspects, the at least one processor may be programmed or configured to, in response to receiving the payment request, automatically apply the offer data to at least one of the transaction and the user account.

In some non-limiting embodiments or aspects, the at least one processor may be programmed or configured to receive the account data associated with the user account of the user before determining the offer; and determine whether the user is eligible for the offer based on the account data associated with the user account of the user.

In some non-limiting embodiments or aspects, when determining whether the user is eligible for the offer, the at least one processor may be programmed or configured to: query a database in response to receiving the account data associated with the user account of the user; and receive the offer data from the database.

In some non-limiting embodiments or aspects, when generating the machine-readable indicia, the at least one processor may be programmed or configured to: generate the encoded data by encoding the at least a portion of the transaction data and the offer data; and generate the machine-readable indicia including the encoded data in response to determining the user is eligible for an offer.

In some non-limiting embodiments or aspects, the encoded data may include a plurality of fields, and, when generating the machine-readable indicia including the encoded data, the at least one processor may be programmed or configured to: receive the offer data from a merchant server; modify a data structure for the machine-readable indicia by embedding the offer data into a field of the plurality of fields and embedding the at least a portion of transaction data in at least one other field of the plurality of fields; and generate the machine-readable indicia based on the data structure and at least one indicia generation algorithm.

In some non-limiting embodiments or aspects, the machine-readable indicia may be at least one of the following: a two-dimensional barcode, a quick response (QR) code, a Bharat QR code, or any combination thereof.

In some non-limiting embodiments or aspects, the at least one processor may be further programmed or configured to: generate a push notification including the offer data in response to the transaction being authorized; and communicate the push notification to a user device of the user.

In some non-limiting embodiments or aspects, the transaction may be a push payment transaction initiated by the user.

According to non-limiting embodiments or aspects, provided is a computer program product for encoding offers. In some non-limiting embodiments or aspects, the computer program product may include at least one non-transitory computer-readable medium including program instructions that, when executed by at least one processor, cause the at least one processor to receive transaction data for a transaction between a user and a merchant. In some non-limiting embodiments or aspects, the instructions may cause the at least one processor to determine an offer based on the transaction data, the offer corresponding to offer data. In some non-limiting embodiments or aspects, the instructions may cause the at least one processor to generate machine-readable indicia including encoded data, the encoded data including at least a portion of the transaction data and the offer data. In some non-limiting embodiments or aspects, the instructions may cause the at least one processor to receive a payment request from a user device of the user based on the encoded data and account data associated with a user account of the user. In some non-limiting embodiments or aspects, the instructions may cause the at least one processor to, in response to receiving the payment request, automatically apply the offer data to at least one of the transaction and the user account.

In some non-limiting embodiments or aspects, the instructions may cause the at least one processor to receive the account data associated with the user account of the user before determining the offer; and determine whether the user is eligible for the offer based on the account data associated with the user account of the user.

In some non-limiting embodiments or aspects, when determining whether the user is eligible for the offer, the instructions may cause the at least one processor to: query a database in response to receiving the account data associated with the user account of the user; and receive the offer data from the database.

In some non-limiting embodiments or aspects, when generating the machine-readable indicia, the instructions may cause the at least one processor to generate the encoded data by encoding the at least a portion of the transaction data and the offer data; and generate the machine-readable indicia including the encoded data in response to determining the user is eligible for an offer.

In some non-limiting embodiments or aspects, the encoded data may include a plurality of fields, and, when generating the machine-readable indicia including the encoded data, the instructions may cause the at least one processor to: receive the offer data from a merchant server; modify a data structure for the machine-readable indicia by embedding the offer data into a field of the plurality of fields and embedding the at least a portion of transaction data in at least one other field of the plurality of fields; and generate the machine-readable indicia based on the data structure and at least one indicia generation algorithm.

In some non-limiting embodiments or aspects, the machine-readable indicia may be at least one of the following: a two-dimensional barcode, a quick response (QR) code, a Bharat QR code, or any combination thereof.

In some non-limiting embodiments or aspects, the instructions may cause the at least one processor to: generate a push notification including the offer data in response to the transaction being authorized; and communicate the push notification to a user device of the user.

In some non-limiting embodiments or aspects, the transaction may be a push payment transaction initiated by the user.

Other non-limiting embodiments or aspects will be set forth in the following numbered clauses:

Clause 1: A method for encoding offers, comprising: receiving, by at least one processor, transaction data for a transaction between a user and a merchant; determining, by at least one processor, an offer based on the transaction data, the offer corresponding to offer data; generating, by at least one processor, machine-readable indicia comprising encoded data, the encoded data comprising at least a portion of the transaction data and the offer data; receiving, by at least one processor, a payment request from a user device of the user based on the encoded data and account data associated with a user account of the user; and in response to receiving the payment request, automatically applying, by at least one processor, the offer data to at least one of the transaction and a user account.

Clause 2: The method of clause 1 further comprising: receiving the account data associated with the user account of the user before determining the offer; and determining whether the user is eligible for the offer based on the account data associated with the user account of the user.

Clause 3: The method of clause 1 or 2, wherein determining whether the user is eligible for the offer comprises: querying a database in response to receiving the account data associated with the user account of the user; and receiving the offer data from the database.

Clause 4: The method of any of clauses 1-3, wherein generating the machine-readable indicia comprises: generating the encoded data by encoding the at least a portion of the transaction data and the offer data; and generating the machine-readable indicia comprising the encoded data in response to determining the user is eligible for an offer.

Clause 5: The method of any of clauses 1-4, wherein the encoded data comprises a plurality of fields, and wherein generating the machine-readable indicia comprising the encoded data comprises: receiving the offer data from a merchant server; modifying a data structure for the machine-readable indicia by embedding the offer data into a field of the plurality of fields and embedding the at least a portion of transaction data in at least one other field of the plurality of fields; and generating the machine-readable indicia based on the data structure and at least one indicia generation algorithm.

Clause 6: The method of any of clauses 1-5, wherein the machine-readable indicia is at least one of the following: a two-dimensional barcode, a quick response (QR) code, a Bharat QR code, or any combination thereof.

Clause 7: The method of any of clauses 1-6, further comprising: generating a push notification comprising the offer data in response to the transaction being authorized; and communicating the push notification to a user device of the user.

Clause 8: The method of any of clauses 1-7, wherein the transaction is a push payment transaction initiated by the user.

Clause 9: A system for encoding offers, comprising: at least one processor, the at least one processor programmed or configured to: receive transaction data for a transaction between a user and a merchant; determine an offer based on the transaction data, the offer corresponding to offer data; generate machine-readable indicia comprising encoded data, the encoded data comprising at least a portion of the transaction data and the offer data; receive a payment request from a user device of the user based on the encoded data and account data associated with a user account of the user; and in response to receiving the payment request, automatically apply the offer data to at least one of the transaction and a user account.

Clause 10: The system of clause 9, wherein the at least one processor is further programmed or configured to: receive the account data associated with the user account of the user before determining the offer; and determine whether the user is eligible for the offer based on the account data associated with the user account of the user.

Clause 11: The system of clause 9 or 10, wherein, when determining whether the user is eligible for the offer, the at least one processor is programmed or configured to: query a database in response to receiving the account data associated with the user account of the user; and receive the offer data from the database.

Clause 12: The system of any of clauses 9-11, wherein, when generating the machine-readable indicia, the at least one processor is programmed or configured to: generate the encoded data by encoding the at least a portion of the transaction data and the offer data; and generate the machine-readable indicia comprising the encoded data in response to determining the user is eligible for an offer.

Clause 13: The system of any of clauses 9-12, wherein the encoded data comprises a plurality of fields, and wherein, when generating the machine-readable indicia comprising the encoded data, the at least one processor is programmed or configured to: receive the offer data from a merchant server; modify a data structure for the machine-readable indicia by embedding the offer data into a field of the plurality of fields and embedding the at least a portion of transaction data in at least one other field of the plurality of fields; and generate the machine-readable indicia based on the data structure and at least one indicia generation algorithm.

Clause 14: The system of any of clauses 9-13, wherein the machine-readable indicia is at least one of the following: a two-dimensional barcode, a quick response (QR) code, a Bharat QR code, or any combination thereof.

Clause 15: The system of any of clauses 9-14, wherein the at least one processor is further programmed or configured to: generate a push notification comprising the offer data in response to the transaction being authorized; and communicate the push notification to a user device of the user.

Clause 16: The system of any of clauses 9-15, wherein the transaction is a push payment transaction initiated by the user.

Clause 17: A computer program product for encoding offers comprising at least one non-transitory computer-readable medium including program instructions that, when executed by at least one processor, cause the at least one processor to: receive transaction data for a transaction between a user and a merchant; determine an offer based on the transaction data, the offer corresponding to offer data; generate machine-readable indicia comprising encoded data, the encoded data comprising at least a portion of the transaction data and the offer data; receive a payment request from a user device of the user based on the encoded data and account data associated with a user account of the user; and in response to receiving the payment request, automatically apply the offer data to at least one of the transaction and a user account.

Clause 18: The computer program product of clause 17, wherein the instructions further cause the at least one processor to: receive the account data associated with the user account of the user before determining the offer; and determine whether the user is eligible for the offer based on the account data associated with the user account of the user.

Clause 19: The computer program product of clause 17 or 18, wherein, when determining whether the user is eligible for the offer, the instructions cause the at least one processor to: query a database in response to receiving the account data associated with the user account of the user; and receive the offer data from the database.

Clause 20: The computer program product of any of clauses 17-19, wherein, when generating the machine-readable indicia, the instructions cause the at least one processor to: generate the encoded data by encoding the at least a portion of the transaction data and the offer data; and generate the machine-readable indicia comprising the encoded data in response to determining the user is eligible for an offer.

Clause 21: The computer program product of any of clauses 17-20, wherein the encoded data comprises a plurality of fields, and wherein, when generating the machine-readable indicia comprising the encoded data, the instructions cause the at least one processor to: receive the offer data from a merchant server; modify a data structure for the machine-readable indicia by embedding the offer data into a field of the plurality of fields and embedding the at least a portion of transaction data in at least one other field of the plurality of fields; and generate the machine-readable indicia based on the data structure and at least one indicia generation algorithm.

Clause 22: The computer program product of any of clauses 17-21, wherein the machine-readable indicia is at least one of the following: a two-dimensional barcode, a quick response (QR) code, a Bharat QR code, or any combination thereof.

Clause 23: The computer program product of any of clauses 17-22, wherein the instructions further cause the at least one processor to: generate a push notification comprising the offer data in response to the transaction being authorized; and communicate the push notification to a user device of the user.

Clause 24: The computer program product of any of clauses 17-23, wherein the transaction is a push payment transaction initiated by the user.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for encoding offers according to non-limiting embodiments or aspects;

FIG. 2 is a diagram of non-limiting embodiments or aspects of components of one or more devices of FIG. 1;

FIG. 3 is a flow diagram of a non-limiting embodiment or aspect of a process for encoding offers according to non-limiting embodiments or aspects; and

FIG. 4 is a sequence diagram of a non-limiting embodiment or aspect of a process for encoding offers according to non-limiting embodiments or aspects.

It should be appreciated by those skilled in the art that any block diagrams herein represent conceptual views of illustrative systems embodying the principles of the present subject matter. Similarly, it may be appreciated that any flow charts, flow diagrams, state transition diagrams, pseudo code, and the like represent various processes which may be substantially represented in computer readable medium and executed by a computer or processor, whether or not such computer or processor is explicitly shown.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices that are configured to directly or indirectly communicate with or over one or more networks. The computing device may be a mobile device. In other non-limiting embodiments or aspects, the computing device may be a desktop computer, a server, a group of servers, or other non-mobile computer. Furthermore, the term “computer” may refer to any computing device that includes the necessary components to receive, process, and output data, and normally includes a display, a processor, a memory, an input device, and a network interface. The term “application” or “application program interface” (API) may refer to computer code or other data sorted on a computer-readable medium that may be executed by a processor to facilitate the interaction between software components, such as a client-side front-end and/or server-side back-end for receiving data from the client. The term “interface” may refer to a generated display, such as one or more graphical user interfaces (GUIs) with which a user may interact, either directly or indirectly (e.g., through a keyboard, mouse, etc.).

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “POS system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. The term “client device,” as used herein, refers to any electronic device that is configured to communicate with one or more servers or remote devices and/or systems. A client device may include a mobile device, a network-enabled appliance (e.g., a network-enabled television, refrigerator, thermostat, and/or the like), a computer, a POS system, and/or any other device or system capable of communicating with a network.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, POS devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “system” may refer to one or more computing devices or combinations of computing devices such as, but not limited to, processors, servers, client devices, software applications, and/or other like components.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Provided herein are improved systems, methods, and computer program products for encoding offers by embedding loyalty data in machine-readable indicia. Such systems provide improvements to payment systems by enabling users to dynamically embed and/or extract data from a code (e.g., a two-dimensional barcode such as a QR code and/or a BQR code) in the context of push payment transactions. In particular, for a transaction between a user and a merchant, the merchant may dynamically embed encoded data in a barcode using a previously unused field of the barcode. The embedded data may include details of an offer (e.g., loyalty points, rewards, etc.) that may be activated upon authorization of a transaction performed using the barcode. The offer data may be stored in a database until the user redeems the offer during a subsequent transaction.

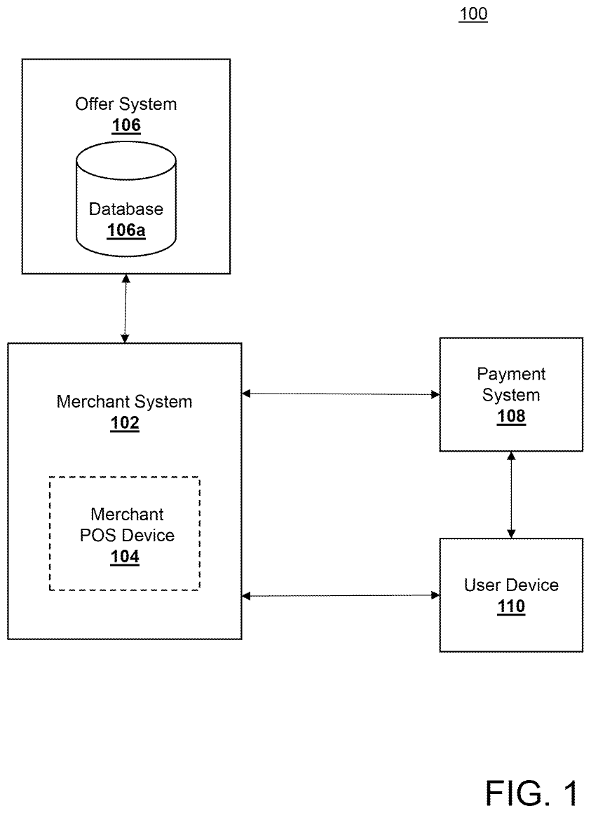

FIG. 1 is a schematic diagram of a system 100 for encoding offers according to some non-limiting embodiments or aspects. System 100 may include merchant system 102, offer system 106, payment system 108, and/or user device 110. Merchant system 102, offer system 106, payment system 108, and/or user device 110 may interconnect (e.g., establish a connection to communicate) via wired connections, wireless connections, or a combination of wired and wireless connections.

Merchant system 102 may include one or more devices configured to communicate with offer system 106, payment system 108, and/or user device 110 via a wired or wireless connection (not shown). For example, merchant system 102 may include one or more computing devices such as a server, a group of servers, and/or other like devices. In some non-limiting embodiments or aspects, merchant system 102 may be associated with a transaction processing system, as described herein. In some non-limiting embodiments or aspects, merchant system 102 may include at least one memory configured to store data (e.g., transaction data). Transaction data may include information for conducting a payment transaction, such as a recipient (e.g., payee) account associated with the merchant, a transaction value, a merchant identifier, a date/time, and/or other like information.

In some non-limiting embodiments or aspects, merchant system 102 may be in communication with a data storage device, which may be local or remote to merchant system 102. In some non-limiting embodiments or aspects, merchant system 102 may be capable of receiving information from, storing information in, transmitting information to, and/or searching information stored in offer system 106, payment system 108, and/or user device 110.

In some non-limiting embodiments or aspects, merchant system 102 may include merchant POS device 104. Merchant POS device 104 may include one or more devices configured to communicate with offer system 106, payment system 108, and/or user device 110 via a wired or wireless connection to conduct a payment transaction. For example, merchant POS device 104 may include a computing device, such as a desktop computer, a portable computer (e.g., a tablet computer, a laptop computer, and/or the like), a mobile device (e.g., a cellular phone, a smartphone, a PDA, a wearable device, and/or the like), and/or other like devices. In some non-limiting embodiments or aspects, merchant POS device 104 may be associated with a user (e.g., an individual operating merchant POS device 104). Merchant POS device 104 may be a device operated by an issuer institution, a merchant, or the like. It will be appreciated that other types of users may operate the merchant POS device 104.

Offer system 106 may include one or more devices configured to communicate with merchant system 102 via a wired or wireless communication connection. For example, offer system 106 may include a computing device, such as a server, a group of servers, and/or other like devices. In some non-limiting embodiments or aspects, offer system 106 may be associated with a transaction processing system, an issuer system, a payment system, and/or a third-party system. In some non-limiting embodiments or aspects, offer system 106 may be part of (e.g., integrated with) merchant system 102 and/or payment system 108. In some non-limiting embodiments or aspects, offer system 106 may be independent of merchant system 102 and payment system 108. In some non-limiting embodiments or aspects, offer system 106 may include at least one memory configured to store data. In some non-limiting embodiments or aspects, offer system 106 may include database 106a.

Database 106a may be stored on one or more devices configured to communicate with merchant system 102 via a wired or wireless communication connection. For example, database 106a may be stored on a data storage unit, such as a hard disk drive, a memory, and/or the like, that is part of and/or in communication with a computing device, such as a server, a group of servers, and/or other like devices. In some non-limiting embodiments or aspects, database 106 may be associated with a transaction processing system, an issuer system, a payment system, and/or a third-party system.

Payment system 108 may include may include one or more devices configured to communicate with merchant system 102 and/or user device 110 via a wired or wireless connection (not shown). For example, payment system 108 may include a server, a group of servers, and/or other like devices. In some non-limiting embodiments or aspects, payment system 108 may be associated with a transaction processing system, as described herein. For example, payment system 108 may be a server computer of a transaction processing system that is configured in an electronic payment network. In some non-limiting embodiments or aspects, payment system 108 may include at least one memory configured to store data (e.g., transaction data).

In some non-limiting embodiments or aspects, payment system 108 may be in communication with a data storage device, which may be local or remote to payment system 108. In some non-limiting embodiments or aspects, payment system 108 may be capable of receiving information from, storing information in, transmitting information to, and/or searching information stored in merchant system 102 and/or user device 110.

User device 110 may include one or more devices capable of receiving information from and/or communicating information to merchant system 102 and/or payment system 108 via the communication network (not shown). For example, user device 110 may include a computing device, such as a desktop computer, a portable computer (e.g., tablet computer, a laptop computer, and/or the like), a mobile device (e.g., a cellular phone, a smartphone, a PDA, a wearable device, and/or the like), and/or other like devices. In some non-limiting embodiments or aspects, user device 110 may be associated with a user (e.g., an individual operating user device).

In some non-limiting embodiments or aspects, the system 100 may include a communication network (not shown) which may include one or more wired and/or wireless network connections, private and/or public network connections, and/or the like. For example, the communication network may include a cellular network (e.g., a long-term evolution (LTE®) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

In some non-limiting embodiments or aspects, merchant system 102 may receive transaction data for a transaction between a user and a merchant. In some non-limiting embodiments or aspects, merchant system 102 may determine an offer based on the transaction data, where the offer corresponds to (e.g., is represented by) offer data. In some non-limiting embodiments or aspects, merchant system 102 may generate machine-readable indicia including encoded data, where the encoded data includes (e.g., represents in encoded form) at least a portion of the transaction data and the offer data. In some non-limiting embodiments or aspects, merchant system 102 may receive a payment request from a user device of the user based on the encoded data and account data associated with the user. In some non-limiting embodiments or aspects, merchant system 102 may, in response to receiving the payment request, automatically apply the offer data to at least one of the transaction and the user account. For example, the offer data may include an offer of a discount (e.g., a reduced transaction value), an offer of a benefit to a user account for future purchases, and/or other like offers that provide a benefit to the transaction, future transactions, and/or the user account.

The number and arrangement of devices shown in FIG. 1 are provided as an example. There may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of system 100 may perform one or more functions described as being performed by another set of devices of system 100.

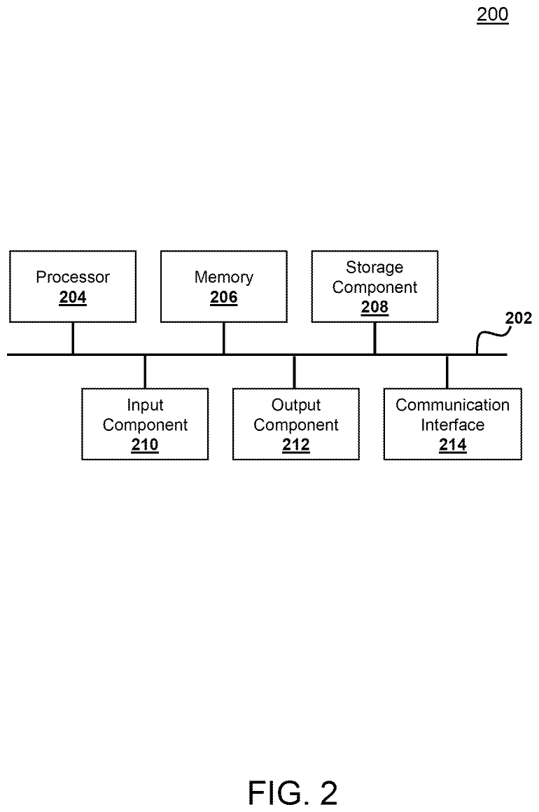

Referring now to FIG. 2, shown is a diagram of example components of a device 200. Device 200 may correspond to merchant system 102 (e.g., one or more devices of merchant system 102), merchant POS device 104 (e.g., one or more devices or merchant POS device 104), offer system 106 (e.g., one or more devices of offer system106), database 106a (e.g., one or more devices of database 106a), payment system 108 (e.g., one or more devices of payment system 108), and/or user device 110. In some non-limiting embodiments or aspects, merchant system 102, merchant POS device 104, offer system 106, database 106a, payment system 108, and/or user device 110 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage memory (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

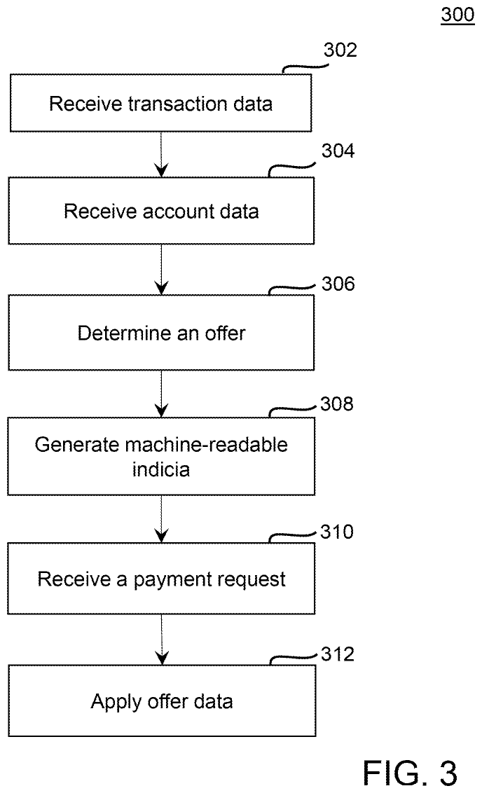

FIG. 3 is a flow diagram of a process 300 for encoding offers according to some non-limiting embodiments or aspects. In some non-limiting embodiments or aspects, one or more steps of process 300 may be performed (e.g., completely, partially, etc.) by merchant system 102 (e.g., one or more devices of merchant system 102). In some non-limiting embodiments or aspects, one or more steps of process 300 may be performed (e.g., completely, partially, etc.) by another device or group of devices separate from or including merchant system 102 (e.g., one or more devices of merchant system 102), merchant POS device 104 (e.g., one or more devices of merchant POS device 104), offer system 106 (e.g., one or more devices of offer system 106), database 106a (e.g., one or more devices of database 106a), payment system 108 (e.g., one or more devices of payment system 108), and/or user device 110. It will be appreciated that, in non-limiting embodiments, fewer, additional, and/or a different order of steps may be implemented. In non-limiting embodiments, a step may be performed automatically in response to performance of a previous step.

As shown in FIG. 3, at step 302, process 300 includes receiving transaction data. For example, merchant system 102 may receive transaction data for a transaction between a user and a merchant. The transaction data may include a transaction date, a transaction time, a transaction amount, a product identification number, and/or the like.

As shown in FIG. 3, at step 304, process 300 includes receiving account data. For example, merchant system 102 may receive account data associated with an account of the user. The account data may include an account identifier, such as a token associated with the account, a PAN, user data, such as a user identifier associated with the account (e.g., a telephone number, an email address, and/or the like), and/or other identifying information. Additionally, the account data may include historical transaction data for a transaction between the user and the merchant. In some non-limiting embodiments or aspects, merchant system 102 may store the account data in a database of merchant system 102 (not shown).

As shown in FIG. 3, at step 306, process 300 includes determining an offer. For example, merchant system 102 may determine an offer based on the transaction data and/or the historical transaction data. In some non-limiting embodiments or aspects, the offer may correspond to the transaction data and/or the historical transaction data. For example, one or more parameters of the transaction data and/or the historical transaction data may correspond to one or more offers in an offer database (e.g., offer database 106a). This may include, as an example, a threshold transaction value, a range of transaction values, a time and/or date of a transaction, a merchant identifier, and/or the like.

In some non-limiting embodiments or aspects, merchant system 102 may determine the offer after receiving the account data associated with the user account of the user. Merchant system 102 may determine whether the user is eligible for the offer based on the account data associated with the user account of the user. For example, certain types of accounts, locations of users, and/or other like parameters may be used to determine an offer.

In some non-limiting embodiments or aspects, determining whether the user is eligible for the offer may include querying a database. For example, merchant system 102 may query offer system 106 to determine whether the user is eligible for the offer in response to receiving the account data associated with the user account of the user. The query may include an account identifier, a user identifier, and/or the like. In some non-limiting embodiments or aspects, merchant system 102 may receive offer data from offer system 106 in response to the query. In some non-limiting embodiments or aspects, the offer data may include an offer identifier.

As shown in FIG. 3, at step 308, process 300 includes generating machine-readable indicia. For example, merchant system 102 may generate machine-readable indicia. The machine-readable indicia may include encoded data including at least a portion of the transaction data and/or a portion of the offer data.

In some non-limiting embodiments or aspects, when generating the machine-readable indicia, merchant system 102 may generate the encoded data by encoding at least a portion of the transaction data and/or the offer data. Merchant system 102 may generate the encoded data in response to determining the user is eligible for the offer.

In some non-limiting embodiments or aspects, the encoded data may include a plurality of fields of a data structure. In some non-limiting embodiments or aspects, when generating the machine-readable indicia including the encoded data, merchant system 102 may receive the offer data from a merchant server (e.g., a server associated with the merchant). In some non-limiting embodiments or aspects, merchant system 102 may modify a data structure of the machine-readable indicia by embedding the offer data into a field of the plurality of fields and/or embedding the at least a portion of transaction data in at least one other field of the plurality of fields, in response to receiving the offer data from the merchant server. In some non-limiting embodiments or aspects, merchant system 102 may generate the machine-readable indicia based on the data structure. In some non-limiting embodiments or aspects, merchant system 102 may generate the machine-readable indicia based on one or more indicia generation algorithms.

In some non-limiting embodiments or aspects, the machine-readable indicia may include a two-dimensional barcode, such as a matrix barcode (e.g., a QR code, a BQR code, or the like). It will be appreciated, however, that any machine-readable indicia that can be encoded with data may be used.

In some non-limiting embodiments or aspects, merchant system 102 may display the machine-readable indicia via a display of merchant POS device 104. However, it will be appreciated that the indicia may also be printed, sent to the user device, displayed on a merchant mobile device, and/or the like.

In some non-limiting embodiments or aspects, user device 110 may be configured to scan (e.g., read) the machine-readable indicia to initiate the push payment transaction with the merchant. In some non-limiting embodiments or aspects, the machine-readable indicia may include the transaction data (e.g., a transaction amount, a transaction date, a transaction time, etc.), account data associated with the account of the user (e.g., an account identifier associated with a user account of the user, a PAN, etc.), account data associated with the merchant (e.g., an account identifier associated with a merchant account of the merchant), and/or any combination thereof.

In some non-limiting embodiments or aspects, user device 110 may be configured to extract the encoded data from the machine-readable indicia in response to scanning the machine-readable indicia. In some non-limiting embodiments or aspects, user device 110 may generate the payment request based on the encoded data. In some non-limiting embodiments or aspects, user device 110 may communicate the payment request to merchant system 102.

As shown in FIG. 3, at step 310, process 300 includes receiving a payment request. For example, merchant system 102 may receive a payment request from a user device of the user based on the encoded data and/or account data associated with the user.

In some non-limiting embodiments or aspects, a software application provided by an issuer system may be installed on user device 110. In some non-limiting embodiments or aspects, user device 110 may execute a software application for completing the push payment transaction provided by an issuer system (not shown). When initiating the push payment transaction, the user may scan the machine-readable indicia via the software application. In some non-limiting embodiments or aspects, an issuer system may authorize the transaction. For example, a server associated with the issuer system may authorize the push payment transaction. The software application may be a client-side application that communicates with an issuer server, a server-side application that is interacted with through a web browser, and/or the like.

As shown in FIG. 3, at step 312, process 300 includes applying offer data. For example, merchant system 102 may automatically apply the offer data to the transaction and/or the user account in response to receiving the payment request from user device 110. In some non-limiting embodiments or aspects, the offer data may be stored along with an account identifier of the user account in database 106a.

In some non-limiting embodiments or aspects, merchant system 102 and/or user device 110 may receive a push notification including a confirmation that the push payment transaction is successful and/or the offer data is applied. For example, merchant system 102 and/or user device 110 may automatically receive a push notification including a confirmation that the push payment transaction is authorized and/or the offer data is applied. In some non-limiting embodiments or aspects, the push notification may be generated and/or communicated by payment system 108.

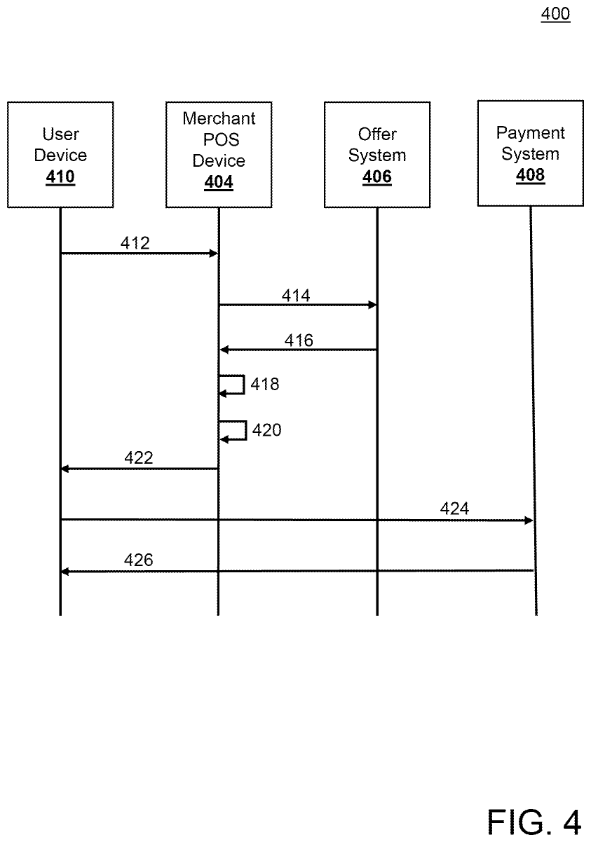

Referring now to FIG. 4, shown is a sequence diagram of a process 400 for encoding offers according to some non-limiting embodiments or aspects. In some non-limiting embodiments or aspects, one or more steps of process 400 may be performed (e.g., completely, partially, etc.) by merchant POS device 404 (e.g., one or more devices of merchant POS device 404). In some non-limiting embodiments or aspects, one or more steps of process 400 may be performed (e.g., completely, partially, etc.) by another device or group of devices separate from or including merchant POS device 404 (e.g., one or more devices of merchant POS device 404), offer system 406 (e.g., one or more devices of offer system 406), payment system 408 (e.g., one or more devices of payment system 408), and/or user device 410. It will be appreciated that, in non-limiting embodiments, fewer, additional, and/or a different order of steps may be implemented. In non-limiting embodiments, a step may be performed automatically in response to performance of a previous step.

In some non-limiting embodiments or aspects, merchant POS device 404 may be the same as, similar to, and/or part of merchant POS device 104. In some non-limiting embodiments or aspects, offer system 406 may be the same as, similar to, and/or part of offer system 106. In some non-limiting embodiments or aspects, payment system 408 may be the same as, similar to, and/or part of payment system 108. In some non-limiting embodiments or aspects, user device 410 may be the same as, similar to, and/or part of user device 110.

In some non-limiting embodiments or aspects, merchant POS device 404 may receive transaction data for a transaction between a user and a merchant. The transaction data may include a transaction date, a transaction time, a transaction amount, a product identification number, etc. In response to receiving the transaction data, merchant POS device 404 may generate and/or send a request message to user device 410. For example, merchant POS device 404 may generate and/or send a request message including a request for account data associated with an account of a user to user device 410.

As shown in FIG. 4, at step 412, user device 410 may generate and/or send a response message including the account data to merchant POS device 404. In some non-limiting embodiments or aspects, the account data may include an account identifier and/or user identifier, such as a telephone number, email address, PAN, user identification name, user identification number, or any other identifier associated with the user account of the user, and/or any combination thereof.

In some non-limiting embodiments or aspects, a user (e.g., a merchant or a customer) may enter the account data as an input to merchant POS device 404. For example, the merchant may enter the data as an input to merchant POS device 404 via a user interface displayed by a display of merchant POS device 404. In other examples, the customer may provide the account data from their device through a wireless communication, an Internet connection, and/or the like.

As shown in FIG. 4, at step 414, in response to receiving the account data, merchant POS device 404 may generate and/or send a request message to offer system 406. For example, merchant POS device 404 may send a request message including the account data and/or transaction data associated with the transaction to offer system 406. In some non-limiting embodiments or aspects, the request message may include a request to retrieve offer data based on the account data and/or transaction data.

In some non-limiting embodiments or aspects, merchant POS device 404 may query offer system 406 to determine whether the user is eligible for the offer in response to receiving the account data associated with the user account of the user.

In some non-limiting embodiments or aspects, offer system 406 may include a user account database, an offer database, and/or a transaction database. In some non-limiting embodiments or aspects, the user account database may store data associated with a plurality of user accounts and/or offer data corresponding to one or more user accounts of the plurality of user accounts.

As shown in FIG. 4 at step 416, offer system 406 may generate and/or send a response message to merchant POS device 404. For example, offer system 406 may send a response message to merchant POS device 404 including the account data and/or the offer data retrieved from the database in response to receiving the request message.

In some non-limiting embodiments or aspects, the response message including the offer data may further include an indication of whether the user associated with the user account is eligible for an offer.

As shown in FIG. 4, at step 418, merchant POS device 404 may determine whether the user is eligible for the offer based on the response message received from offer system 406.

In some non-limiting embodiments or aspects, merchant POS device 404 may determine an offer based on the account data, transaction data, and/or the offer data.

As shown in FIG. 4, at step 420, merchant POS device 404 may generate machine-readable indicia. In some non-limiting embodiments or aspects, the machine-readable indicia may include a two-dimensional barcode, a QR code, a BQR code, or any combination thereof. In some non-limiting embodiments or aspects, if the user is eligible for the offer, the merchant may enter offer data including one or more details of the offer as input to merchant POS device 404. In some non-limiting embodiments or aspects, a structure of the machine-readable indicia may be modified in response to the merchant entering the one or more details of the offer. For example, merchant POS device 404 may modify a data structure of the machine-readable indicia by embedding the offer data into a field of the plurality of fields and/or embedding the at least a portion of transaction data in at least one other field of the plurality of fields, in response to receiving the offer data from the merchant server. In some non-limiting embodiments or aspects, merchant POS device 404 may generate the machine-readable indicia based on the data structure. In some non-limiting embodiments or aspects, merchant POS device 404 may generate the machine-readable indicia based on one or more indicia generation algorithms.

The machine-readable indicia may include encoded data including at least a portion of the transaction data and/or a portion of the offer data. In some non-limiting embodiments or aspects, when generating the machine-readable indicia, merchant POS device 404 may generate the encoded data by encoding at least a portion of the transaction data and the offer data. In some non-limiting embodiments or aspects, merchant POS device 404 may generate the encoded data in response to determining that the user is eligible for the offer.

As shown in FIG. 4, at step 422, merchant POS device 404 may display and/or send the machine-readable indicia to user device 410.

In some non-limiting embodiments or aspects, merchant POS device 404 may display the machine-readable indicia to the user via a display of merchant POS device 404. The user device 410 may be configured to scan (e.g., read) the machine-readable indicia and extract transaction data and/or offer data from the machine-readable indicia.

In some non-limiting embodiment or aspects, in response to scanning the machine-readable indicia, user device 410 may initiate a push payment transaction with merchant POS device 404.

As shown in FIG. 4, at step 424, in response to initiating the push payment transaction, user device 410 may send the transaction data, offer data, and/or account data to payment system 408 to process the push payment transaction.

In some non-limiting embodiments or aspects, payment system 408 may generate and/or send an authorization request message to an issuer server (not shown). In response to sending the authorization request message, payment system 408 may receive an authorization response message indicating the push payment transaction is authorized. Payment system 408 may generate and/or send a push notification to user device 410 in response to receiving the authorization response message indicating the push payment transaction is authorized in step 426. In some non-limiting embodiments or aspects, the push notification may comprise the offer data and/or a confirmation that the transaction is successful.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A method for encoding offers, comprising:
receiving, by at least one processor, transaction data for a transaction between a user and a merchant;
receiving, by at least one processor, account data associated with a user account of the user, the account data comprising a user identifier associated with the user;
in response to receiving the user identifier, sending, by at least one processor, a request message to retrieve offer data based on the transaction data and the user identifier to an offer system, the request message comprising the transaction data and the user identifier, wherein the offer system comprises a database storing data associated with a plurality of user accounts and offer data corresponding to one or more user accounts of the plurality of user accounts;
receiving, by at least one processor, a response message from the offer system, the response message comprising the user identifier and the offer data retrieved from the database in response to receiving the request message;
determining, by at least one processor, an offer based on the transaction data and the user identifier, the offer corresponding to the offer data;
generating, by at least one processor, machine-readable indicia comprising encoded data, the encoded data comprising a plurality of fields;
modifying, by at least one processor, a data structure of the machine-readable indicia by embedding the offer data into a field of the plurality of fields in response to receiving one or more details of the offer to provide a modified machine-readable indicia;
displaying, by at least one processor via a display of a merchant point-of-sale device, the modified machine-readable indicia to the user;
receiving, by at least one processor, a payment request from a user device of the user based on the modified machine-readable indicia and the account data associated with the user account of the user; and
in response to receiving the payment request, automatically applying, by at least one processor, the offer data to at least one of the transaction and the user account.

2. The method of claim 1 further comprising:
determining whether the user is eligible for the offer based on the account data associated with the user account of the user.

3. The method of claim 2, wherein determining whether the user is eligible for the offer comprises:
querying the database in response to receiving the account data associated with the user account of the user; and
receiving the offer data from the database.

4. The method of claim 2, wherein generating the machine-readable indicia comprises:
generating the encoded data by encoding at least a portion of the transaction data and the offer data; and
generating the machine-readable indicia comprising the encoded data in response to determining the user is eligible for the offer.

5. (canceled)

6. The method of claim 1, wherein the machine-readable indicia is at least one of the following: a two-dimensional barcode, a quick response (QR) code, a Bharat QR code, or any combination thereof.

7. The method of claim 1, further comprising:
generating a push notification comprising the offer data in response to the transaction being authorized; and
communicating the push notification to the user device of the user.

8. The method of claim 1, wherein the transaction is a push payment transaction initiated by the user.

9. A system for encoding offers, comprising:
at least one processor, the at least one processor programmed or configured to:
receive transaction data for a transaction between a user and a merchant;
receive account data associated with a user account of the user, the account data comprising a user identifier associated with the user;
in response to receiving the user identifier, send a request message to retrieve offer data based on the transaction data and the user identifier to an offer system, the request message comprising the transaction data and the user identifier, wherein the offer system comprises a database storing data associated with a plurality of user accounts and offer data corresponding to one or more user accounts of the plurality of user accounts;
receive a response message from the offer system, the response message comprising the user identifier and the offer data retrieved from the database in response to receiving the request message;
determine an offer based on the transaction data and the user identifier, the offer corresponding to the offer data;
generate machine-readable indicia comprising encoded data, the encoded data comprising a plurality of fields;
modify a data structure of the machine-readable indicia by embedding the offer data into a field of the plurality of fields in response to receiving one or more details of the offer to provide a modified machine-readable indicia;
display, via a display of a merchant point-of-sale device, the modified machine-readable indicia to the user;
receive a payment request from a user device of the user based on the modified machine-readable indicia and the account data associated with the user account of the user; and
in response to receiving the payment request, automatically apply the offer data to at least one of the transaction and the user account.

10. The system of claim 9, wherein the at least one processor is further programmed or configured to:
determine whether the user is eligible for the offer based on the account data associated with the user account of the user.

11. The system of claim 10, wherein, when determining whether the user is eligible for the offer, the at least one processor is programmed or configured to:
query the database in response to receiving the account data associated with the user account of the user; and
receive the offer data from the database.

12. The system of claim 10, wherein, when generating the machine-readable indicia, the at least one processor is programmed or configured to:
generate the encoded data by encoding at least a portion of the transaction data and the offer data; and
generate the machine-readable indicia comprising the encoded data in response to determining the user is eligible for the offer.

13. (canceled)

14. The system of claim 9, wherein the machine-readable indicia is at least one of the following: a two-dimensional barcode, a quick response (QR) code, a Bharat QR code, or any combination thereof.

15. The system of claim 9, wherein the at least one processor is further programmed or configured to:
generate a push notification comprising the offer data in response to the transaction being authorized; and
communicate the push notification to the user device of the user.

16. The system of claim 9, wherein the transaction is a push payment transaction initiated by the user.

17. A computer program product for encoding offers comprising at least one non-transitory computer-readable medium including program instructions that, when executed by at least one processor, cause the at least one processor to:
receive transaction data for a transaction between a user and a merchant;
receive account data associated with a user account of the user, the account data comprising a user identifier associated with the user;
in response to receiving the user identifier, send a request message to retrieve offer data based on the transaction data and the user identifier to an offer system, the request message comprising the transaction data and the user identifier, wherein the offer system comprises a database storing data associated with a plurality of user accounts and offer data corresponding to one or more user accounts of the plurality of accounts;
receive a response message from the offer system, the response message comprising the user identifier and offer data retrieved from the database in response to receiving the request message;
determine an offer based on the transaction data and the user identifier, the offer corresponding to the offer data;
generate machine-readable indicia comprising encoded data, the encoded data comprising a plurality of fields;
modifying a data structure of the machine-readable indicia by embedding the offer data into a field of the plurality of fields in response to receiving one or more details of the offer to provide a modified machine-readable indicia;
display, via a display of a merchant point-of-sale device, the modified machine-readable indicia to the user;
receive a payment request from a user device of the user based on the modified machine-readable indicia and the account data associated with the user account of the user; and
in response to receiving the payment request, automatically apply the offer data to at least one of the transaction and the user account.

18. The computer program product of claim 17, wherein the instructions further cause the at least one processor to:
determine whether the user is eligible for the offer based on the account data associated with the user account of the user, wherein, when determining whether the user is eligible for the offer, the instructions further cause the at least one processor to:
query the database in response to receiving the account data associated with the user account of the user; and
receive the offer data from the database.

19. The computer program product of claim 18, wherein, when generating the machine-readable indicia, the instructions cause the at least one processor to:
generate the encoded data by encoding at least a portion of the transaction data and the offer data; and
generate the machine-readable indicia comprising the encoded data in response to determining the user is eligible for an offer.

20. The computer program product of claim 17, wherein the instructions further cause the at least one processor to:
generate a push notification comprising the offer data in response to the transaction being authorized; and
communicate the push notification to the user device of the user.
